(19) United States
(12) Patent Application Publication
(10) Pub. No.: US 2021/0247709 A1
(43) Pub. Date: Aug. 12, 2021

(54) FIXING DEVICE AND IMAGE FORMING APPARATUS

(71) Applicant: KYOCERA Document Solutions Inc., Osaka-shi (JP)

(72) Inventor: Takefumi YOTSUTSUJI, Osaka-shi (JP)

(21) Appl. No.: 17/165,118

(22) Filed: Feb. 2, 2021

(30) Foreign Application Priority Data
Feb. 6, 2020 (JP) 2020-018689

(51) Int. Cl. G03G 15/20; G03G 15/00

(52) U.S. Cl. CPC G03G 15/205; G03G 15/50; G03G 15/2064

(57) ABSTRACT

A fixing device is provided with a rotatable fixing member, a pressure roller for holding and conveying a sheet between the pressure roller and the fixing member, a driving unit for driving the pressure roller or the fixing member, a heating unit for heating the fixing member, and a control unit for receiving an instruction for designating any of a first mode in which a temperature of the fixing member is raised at a first temperature raising speed and a second mode in which a temperature of the fixing member is raised at a second temperature raising speed slower than the first temperature raising speed to reduce a generation amount of ultrafine particles compared with the first mode, and controlling the driving unit or the heating unit so as to raise the temperature of the fixing member to a first temperature at a temperature raising speed corresponding to the instruction.

### INCORPORATION BY REFERENCE

This application is based upon and claims the benefit of priority from the corresponding Japanese Patent Application No. 2020-018689 filed on Feb. 6, 2020, the entire contents of which are incorporated herein by reference.

### BACKGROUND

The present disclosure relates to a fixing device for fixing a toner image on a sheet and an image forming apparatus including the fixing device.

An electrophotographic image forming apparatus is provided with a fixing device for fixing a toner image on a sheet by heating and pressurizing the toner image formed on the sheet. In general, a fixing device includes a fixing member in the form of a roller or on a belt, a pressure roller for holding and conveying a sheet between the pressure roller and the fixing member, and a heating part for heating the fixing member. In order to start the fixing process, warm-up for raising the temperature of the fixing member to a predetermined temperature is required, but during the warm-up, the fixing process cannot be performed, and the fixing device enters a standby state. Therefore, a technique for shortening the warm-up time has been studied.

For example, in an electromagnetic induction heating system having a configuration in which a fixing roller disposed inside the circular path of a cylindrical fixing belt is pressed by a pressure roller from the outside of the circular path through the fixing belt to secure a fixing nip, a value obtained by dividing the inner diameter of the fixing belt by the outer diameter of the fixing roller is set within a predetermined range, thereby raising a temperature raising speed while suppressing flapping of the fixing belt.

Further, in a heating type fixing roller in which an insulating layer and a resistance heat generating layer are laminated on the inner peripheral surface of a metal roller, when the same resin is used for the insulating layer and the resistance heat generating layer and the pattern of the heat generating portion is provided on the resistance heat generating layer, it has been proposed that the temperature raising speed in the heat generating portion at the center in the axial direction is made higher than the temperature raising speed in the heat generating portion at the end in the axial direction.

### SUMMARY

A fixing device according to the present disclosure is provided with a rotatable fixing member, a pressure roller for holding and conveying a sheet between the pressure roller and the fixing member, a driving unit for driving the pressure roller or the fixing member, a heating unit for heating the fixing member, and a control unit for receiving an instruction for designating any of a first mode in which a temperature of the fixing member is raised at a first temperature raising speed, and a second mode in which a temperature of the fixing member is raised at a second temperature raising speed at a second temperature raising speed slower than the first temperature raising speed to reduce the generation amount of ultrafine particles compared with the first mode, and controlling the driving unit or the heating unit so as to raise the temperature of the fixing member to a first temperature at a temperature raising speed corresponding to the instruction.

Also disclosed is a fixing device comprising a rotatable fixing member, a pressure roller for holding and conveying a sheet between the pressure roller and the fixing member, a driving unit for driving the pressure roller or the fixing member, a heating unit for heating the fixing member, and a temperature measurement unit for measuring the temperature of the fixing member, wherein the control unit controls the driving unit or the heating unit so as to raise the temperature of the fixing member to the first temperature at a first temperature raising speed when the temperature measured by the temperature measurement unit is equal to or higher than a second temperature lower than a first temperature, and controls the driving unit or the heating unit so as to raise the temperature of the fixing member at a second temperature raising speed lower than the first temperature raising speed when the temperature measured by the temperature measurement unit is lower than the second temperature.

### BRIEF DESCRIPTION OF THE DRAWINGS

FIG. 1 is a front view schematically showing an internal configuration of a printer according to an embodiment of the present disclosure.

FIG. 2 is a cross-sectional view of a fixing device according to an embodiment of the present disclosure.

FIG. 3 is a block diagram showing an electrical configuration of a printer according to an embodiment of the present disclosure.

FIG. 4 is a view showing an external appearance of a unit according to an embodiment of the present disclosure.

FIG. 5A is a graph showing experimental results.

FIG. 5B is a graph showing experimental results.

FIG. 5C is a graph showing experimental results.

FIG. 6A is a flowchart showing a warm-up control procedure of a fixing device according to an embodiment of the present disclosure.

FIG. 6B is a graph showing a temperature raising speed of fixing roller according to an embodiment of the present disclosure.

FIG. 6C is a graph showing the temperature of a fixing roller according to an embodiment of the present disclosure.

FIG. 7A is a flowchart showing a warm-up control procedure of a fixing device according to a third modification of the present disclosure.

FIG. 7B is a graph showing a temperature raising speed of a fixing roller according to a third modification of the present disclosure.

FIG. 7C is a graph showing the temperature of a fixing roller according to a third variation of the present disclosure.

FIG. 8A is a flowchart showing a warm-up control procedure of a fixing device according to a fourth modification of the present disclosure.

FIG. 8B is a graph showing a temperature raising speed of a fixing roller according to a fourth modification of the present disclosure.

FIG. 8C is a graph showing the temperature of a fixing roller according to a fourth variation of the present disclosure.

### DETAILED DESCRIPTION

Hereinafter, a printer 1 (an example of an image forming apparatus) and a fixing device 9 according to an embodiment of the present disclosure will be described with reference to the drawings.

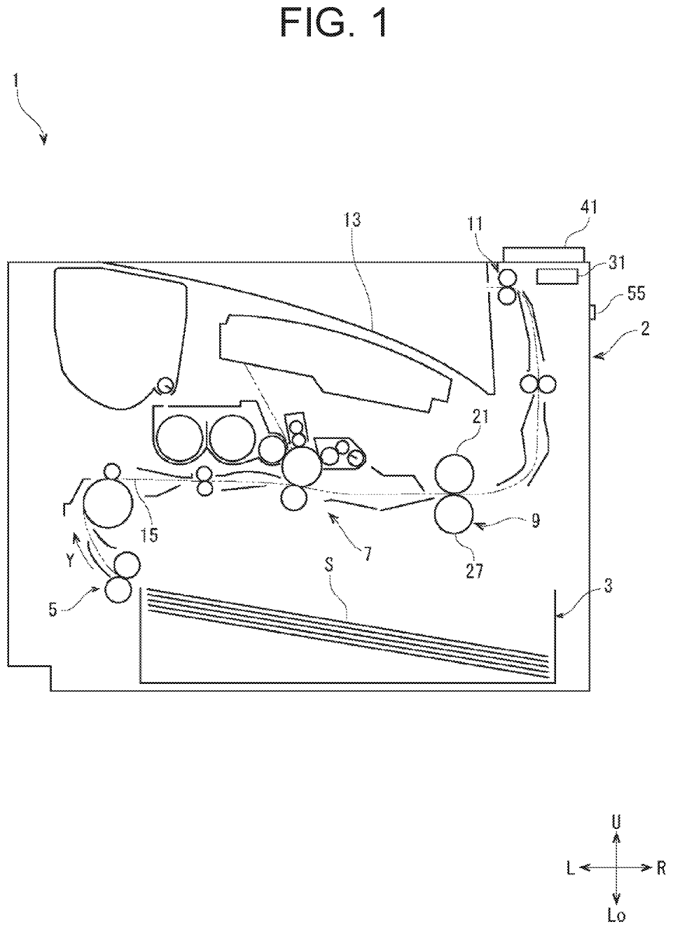

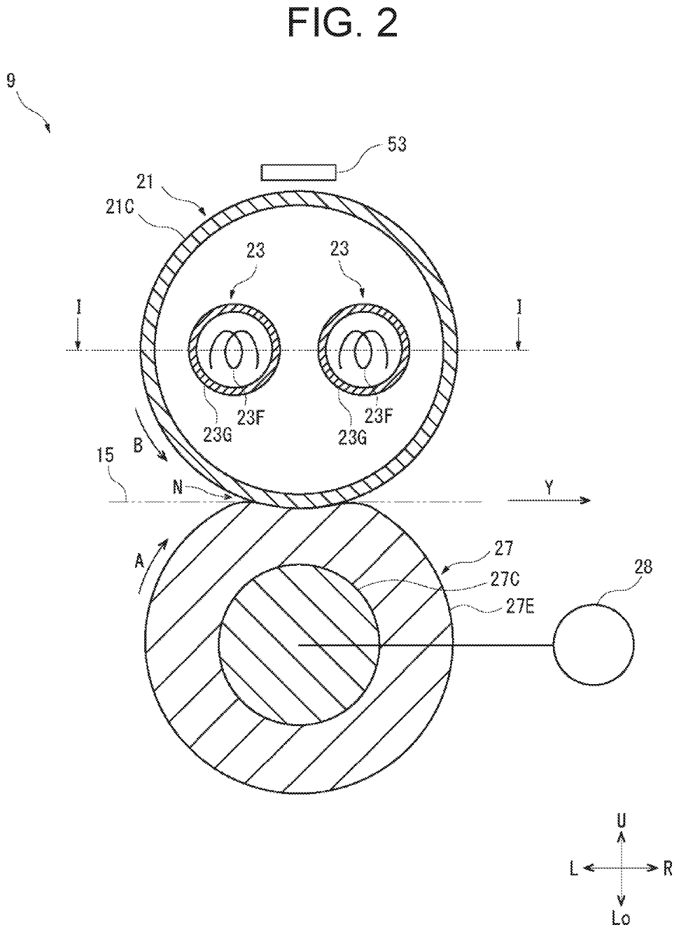

First, a printer 1 (an example of an image forming apparatus) and a fixing device 9 will be described with reference to FIGS. 1 and 2. FIG. 1 is a front view schematically showing an internal configuration of the printer 1. FIG. 2 is a cross sectional view of the fixing device 9. In the following description, a near side (a front side) of a paper surface of FIG. 1 is defined to be a front side of the printer 1, and a left-and-right direction is defined based on a direction in which the printer 1 is viewed from the front side. In each figure, U, Lo, L, R, Fr, and Rr indicate upper, lower, left, right, front, and rear, respectively.

A printer 1 is provided with a main body housing 2 formed in a rectangular parallelepiped shape. The main body housing 2 is provided with a paper feed cassette 3 in which a sheet S is contained, a paper feed roller 5 which feeds the sheet S from the paper feed cassette 3, an image forming device 7 which forms a toner image on the sheet S by an electrophotographic method, a fixing device 9 which heats the toner image and fixes the toner image on the sheet S, a paper discharge roller 11 which discharges the sheet S, and a paper discharge tray 13 in which the discharged sheet S is stacked. The main body housing 2 is provided with a conveying path 15 for the sheet S from the paper feed roller 5 toward the paper discharge roller 11 via the image forming device 7 and the fixing device 9. The sheet S is conveyed along the conveying path 15 in a predetermined conveying direction Y.

[Fixing Device]

The fixing device 9 includes a fixing roller 21 (an example of a rotatable fixing member), a pressure roller 27 for conveying a sheet S while nipping the sheet S between the fixing roller 21, a driving unit 28 for driving the pressure roller 27, and a halogen heater 23 (an example of a heating unit) for heating the fixing roller 21, and is housed in a fixing housing (not shown). In the present embodiment, the fixing device 9 is arranged in a posture in which the pressure roller 27 is positioned below the fixing roller 21, but the fixing device 9 may be arranged in any posture.

[Fixing Roller]

The fixing roller 21 has a cylindrical core metal 21C having a hollow portion penetrating in the front rear direction, and a releasing layer (not shown) formed on the outer peripheral surface of the core metal 21C. The core metal 21C is a thin walled tube made of a metal such as an aluminum alloy or stainless steel. The releasing layer is formed of a PFA (polytetrafluoroethylene perfluoroalkoxyethylene copolymer resin) tube, a PTFE (polytetrafluoroethylene) tube, or the like.

[Pressure Roller, Driving Unit]

The pressure roller 27 includes a cylindrical or cylindrical core metal 27C having a longitudinal direction in the front rear direction, an elastic layer 27E formed on the outer peripheral surface of the core metal 27C, and a releasing layer (not shown) formed on the outer peripheral surface of the elastic layer 27E. The core metal 27C is made of a metal such as an aluminum alloy or stainless steel. The elastic layer 27E is made of silicone rubber or the like. The releasing layer is made of a PFA tube, a PTFE tube or the like. The pressure roller 27 is urged upward by an urging member (not shown) such as a spring and pressed against the fixing roller 21 to form a pressure region N in which the fixing roller 21 and the pressure roller 27 are in surface contact. The pressure roller 27 is driven by a driving unit 28 such as a motor.

[Halogen Heater]

The halogen heater 23 is a rod shaped halogen lamp having a longitudinal direction in the front rear direction, and is provided with a glass tube 23G and a filament 23F contained in the glass tube 23G, and is disposed in a hollow portion of the fixing roller 21.

When the printer 1 receives an image forming job from an external computer or the like, the paper feed roller 5 sends the sheet S to the conveying path 15, and the image forming device 7 forms a toner image on the sheet S in accordance with the image data included in the image forming job. The fixing device 9 transports the sheet S on which the toner image has been formed while holding the sheet S between the fixing roller 21 and the pressure roller 27. Then, the toner image is heated and pressurized, and is fixed on the sheet S. The sheet S on which the toner image has been fixed is discharged to the paper discharge tray 13 by the discharge roller 11.

[Electrical Configuration]

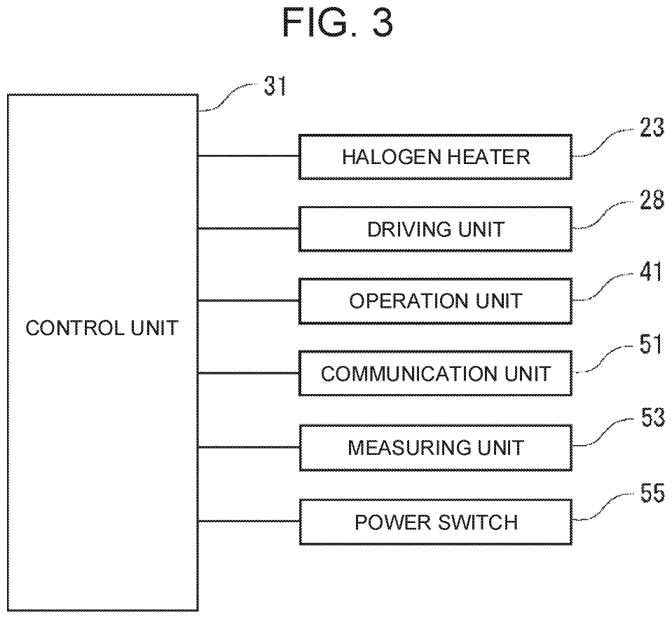

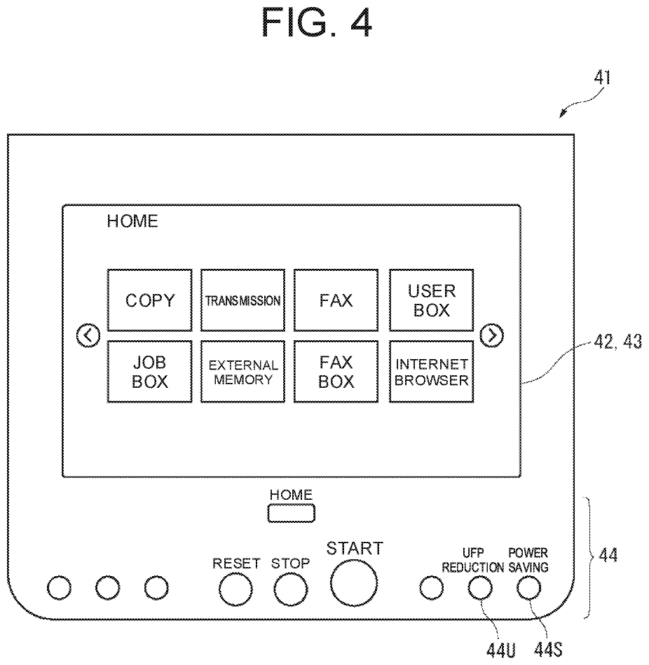

Next, the electrical configuration of the printer 1 will be described. FIG. 3 is a block diagram showing the electrical configuration of the printer 1. FIG. 4 is a view showing the appearance of the operation unit 41. Each unit of the printer 1 is controlled by a control unit 31. The control unit 31 is connected to a halogen heater 23, a driving unit 28, an operation unit 41, a communication unit 51, a temperature measuring unit 53, and a power switch 55.

[Control Unit]

The control unit 31 may be implemented by a processor and software, or may be implemented by hardware such as an integrated circuit. The processor executes various processes by reading and executing programs stored in the memory. For example, a CPU (Central Processing Unit) is used as the processor. The memory includes a storage medium such as a read only memory (ROM), a random access memory (RAM), or an electrically erasable programmable read only memory (EEPROM). A control program used for controlling the printer 1 is stored in the memory.

[Operation Unit]

The operation unit 41 includes, for example, a display panel 42 using a liquid crystal or the like, a touch panel 43 superimposed on the display panel 42, and a keypad 44 adjacent to the touch panel 43, and is provided on the upper portion of the main body housing 2.

The control unit 31 displays information such as an operation menu for operating the printer 1, on the display panel 42, and receives an operation for the printer 1 via the touch panel 43 and the keypad 44.

[Communication Unit]

The communication unit 51 is a communication interface connected to a LAN (Local Area Network). A computer is connected to the LAN, and the computer transmits an image forming job to the printer 1 via the LAN.

[Temperature Measurement Unit]

The temperature measuring unit 53 is, for example, a non-contact thermistor, and is disposed so as to face the outer peripheral surface of the fixing roller 21. The temperature measuring unit 53 measures the surface temperature of the fixing roller 21 and outputs data indicating the measured surface temperature to the control unit 31. The control unit 31 feedback-controls the halogen heater 23 so that the difference between the surface temperature measured by the temperature measuring unit 53 and the set surface temperature falls within a predetermined range.

[Power Switch]

The power switch 55 is provided on the upper portion of the side surface of the main body housing 2. By operating the power switch 55, the power supply from the commercial power supply to the printer 1 is turned on and off.

[Basic Operation of Warm-up]

Next, a basic operation of warm up of the fixing device 9 will be described. Warm-up of the fixing device 9 is executed when the printer 1 is turned on by operating the power switch 55 and when the printer 1 returns from the sleep mode to the normal mode.

When the printer 1 is powered on, the control unit 31 performs warm-up of the fixing device 9. Specifically, the control unit 31 rotates the pressure roller 27 by the driving unit 28 and supplies power to the halogen heater 23. Then, the fixing roller 21 rotates following the pressure roller 27, and the halogen heater 23 generates heat to heat the fixing roller 21. The control unit 31 receives data indicating the surface temperature of the fixing roller 21 from the temperature measuring unit 53 at predetermined intervals, and when the surface temperature reaches a first temperature T1 (for example, 190° C.) suitable for the fixing process, the control unit 31 finishes the warm-up and shifts to the normal mode. In the normal mode, the control unit 31 feedback-controls the power supplied to the halogen heater 23 so that the measured surface temperature falls within a predetermined range including the first temperature T1.

The keypad 44 of the operation unit 41 is provided with a power saving key 44S for receiving an operation designating either the normal mode or the sleep mode. A light source such as an LED (Light Emitting Diode) is provided inside the power saving key 44S, and the power saving key 44S is formed of a resin that transmits light.

The sleep mode is a mode for reducing the power consumption of each part of the printer 1. When neither the operation of the operation unit 41 nor the reception of the image forming job is performed for a predetermined time in the normal mode, or when the power saving key 44S is operated in the normal mode, the control unit 31 shifts the printer 1 to the sleep mode and turns on the light source of the power saving key 44S. In the sleep mode, the control unit 31 stops the heating of the fixing roller 21 by stopping the power supply to the halogen heater 23. Even when the power supply is cut off by the power switch 55, the power supply to the halogen heater 23 is stopped, thereby stopping the heating of the fixing roller 21.

In the sleep mode, when the operation unit 41 (including the power saving key 44S) is operated or an image forming job is received, the control unit 31 performs warm-up of the fixing device 9. When the printer 1 is powered on by the operation of the power switch 55, too, the control unit 31 performs warm-up of the fixing device 9.

[Relationship between Temperature Raising Speed and Generation of Ultrafine Particles]

Next, the relationship between temperature raising speed of the fixing roller 21 and the generation amount of ultrafine particles (UFP) will be described. During warm-up of the fixing device 9, it is known that UFP having a particle diameter of 100 nm or less is generated by aggregation of particles of volatile organic compounds (VOC) evaporated from silicone substances contained in the heated fixing roller 21, lubricant oil, and the like.

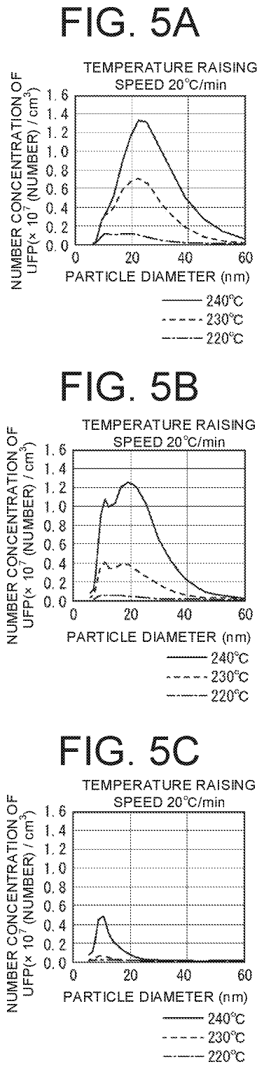

FIGS. 5A to 5C are graphs showing the results of experiments conducted to examine the relationship between the temperature raising speed rate of the fixing roller 21 and the amount of UFP generated. The printer 1 was installed in a chamber having a volume of 5 m3, and the temperature raising speed of a fixing device 9 was controlled by adjusting power supplied to a halogen heater 23 under the conditions of a temperature of 23° C. and an absolute humidity of 50 g/m3, and the number concentration and particle diameter of UFP were measured for each temperature raising speed. As the printer 1, a monochrome printer FS-1040 (printing speed 20 ppm) manufactured by Kyocera Document Solutions Co., Ltd. was used. A high-speed response particle sizer manufactured by TSI Inc. was used to measure the number concentration and particle diameter. The horizontal axis indicates the particle diameter (nm) of the UFP, and the vertical axis indicates the number concentration (number/cm3) of the UFP. FIGS. 5A, 5B, and 5C show the results when the temperature raising speed is 20° C./minute, 10° C./minute, and 1° C./minute, respectively, and the number concentration at the time point of 220° C. (dashed dotted line), 230° C. (dashed line), and 240° C. (solid line) at each temperature raising speed is shown.

According to FIGS. 5A to 5C, it can be seen that the number concentration of the UFP is lower and the particle diameter is smaller as the temperature raising speed is lower, which is considered to be caused by the fact that the generation amount of the VOC decreases as the temperature raising speed is lower, and that the aggregation of the VOC becomes difficult as the temperature raising speed is lower. From this fact, it has been found that the generation amount of the UFP can be reduced by lowering the temperature raising speed of the fixing roller 21.

[Control of Temperature Raising Speed]

Based on the above knowledge, the fixing device 9 according to the present embodiment is configured such that the control unit 31 receives an instruction specifying either a first mode in which the temperature of the fixing roller 21 is raised at the first temperature raising speed or a second mode in which the amount of UFP generated is reduced compared to the first mode by raising the temperature of the fixing roller 21 at the second temperature raising speed slower than the first temperature raising speed, and controls the driving unit 28 so as to raise the temperature of the fixing roller 21 to the first temperature T1 according to the instruction.

Specifically, when the fixing roller 21 is heated, part of the heat applied to the fixing roller 21 moves to the pressure roller 27 in the pressure region N. As the rotation speed of the fixing roller 21 raises, the transfer of heat from the fixing roller 21 to the pressure roller 27 is promoted, so that the temperature raising speed of the fixing roller 21 decreases. In the present embodiment, the temperature raising speed is controlled by the rotational speed of the fixing roller 21 by utilizing this fact. That is, in the first mode, the control unit 31 controls the driving unit 28 so as to rotate the fixing roller 21 at the first rotation speed, thereby raising the temperature of the fixing roller 21 at the first temperature raising speed. On the other hand, in the second mode, the control unit 31 controls the driving unit 28 so as to rotate the fixing roller 21 at a second rotational speed higher than the first rotational speed, thereby raising the temperature of the fixing roller 21 at a second temperature raising speed lower than the first temperature raising speed.

A keypad 44 of the operation unit 41 is provided with a UFP reduction key 44U for receiving an operation for designating either the first mode or the second mode. A light source such as an LED is provided inside the UFP reduction key 44U, and the UFP reduction key 44U is formed of a light transmitting resin.

As an initial setting, a flag indicating the first mode is stored in the EEPROM of the control unit 31. When the UFP reduction key 44U is operated in the first mode, the control unit 31 rewrites the flag indicating the first mode to the flag indicating the second mode and turns on the light source. On the other hand, when the UFP reduction key 44U is operated in the second mode, the control unit 31 rewrites the flag indicating the second mode to the flag indicating the first mode and turns off the light source.

The selection of the first mode and the second mode is performed by the user. For example, when the work efficiency is prioritized over the reduction of the UFP, the user selects the first mode. On the other hand, when the reduction of the UFP is prioritized over the work efficiency, the user selects the second mode. When the UFP reduction key 44U is off, the first mode is set, and when it is on, the second mode is set. When the desired mode is not set, the user specifies the desired mode using the UFP reduction key 44U. When warming up the fixing device 9, the control unit 31 reads out a flag stored in the EEPROM and warms up the fixing device 9 in either the first mode or the second mode according to the flag.

[Warm-Up Control]

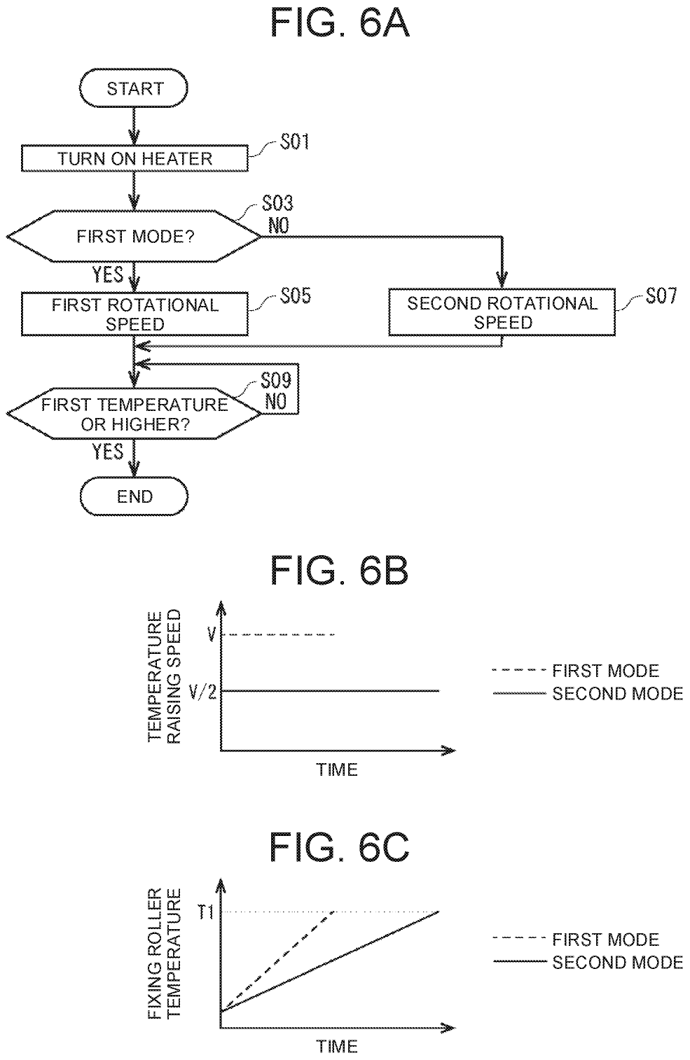

Next, the warm-up control of the fixing device 9 will be described in detail. FIG. 6A is a flowchart showing a warm-up control procedure of the fixing device 9. First, the control unit 31 starts supplying power to the halogen heater 23 (step S01). Next, the control unit 31 reads a flag from the EEPROM and determines whether or not the flag indicates the first mode (step S03). If the control unit 31 determines that the flag indicates the first mode (step S03: YES), the control unit 31 controls the driving unit 28 to rotate the fixing roller 21 at the first rotational speed (step S05), and if it is determined that the flag does not indicate the first mode (indicates the second mode) (step S03: NO), the control unit 31 controls the driving unit 28 to rotate the fixing roller 21 at the second rotational speed (step S07).

Next, the control unit 31 determines whether or not the temperature of the fixing roller 21 measured by the temperature measuring unit 53 is equal to or higher than the first temperature T1 (step S09). If the control unit 31 determines that the temperature of the fixing roller 21 is equal to or higher than the first temperature T1 (step S09: YES), the warm-up is finished, and if the control unit 31 determines that the temperature of the fixing roller 21 is lower than the first temperature T1 (step S09: NO), the control unit 31 repeats the determination in step S09.

FIG. 6B is a graph showing the temperature raising speed of the fixing roller 21, in which the horizontal axis represents time and the vertical axis represents temperature raising speed.

FIG. 6C is a graph showing the temperature of the fixing roller 21, in which the horizontal axis represents time and the vertical axis represents temperature. The first mode is indicated by a broken line and the second mode is indicated by a solid line. FIG. 6C conceptually shows the temperature change assumed under the assumption that the temperature of the fixing roller 21 is raised at the temperature raising speed shown in FIG. 6B. In this example, the temperature raising speed of the first mode is assumed to be a constant value V, while the temperature raising speed of the second mode is assumed to be V/2. Therefore, in the second mode, it is assumed that it takes approximately twice as long as the first mode for the temperature of the fixing roller 21 to reach the first temperature T1.

According to the fixing device 9 according to the present embodiment described above, the control unit 31 receives an instruction specifying either a first mode in which the fixing roller 21 is heated at the first temperature raising speed or a second mode in which the amount of UFP generated is reduced compared with the first mode by heating the fixing roller 21 at the second temperature raising speed slower than the first temperature raising speed, and controls the driving unit 28 so that the fixing roller 21 is heated to the first temperature T1 at the temperature raising speed corresponding to the instruction. Therefore, according to the fixing device 9 according to the present embodiment, the amount of UFP generated when the fixing roller 21 is heated can be reduced.

Here, the present embodiment is compared with the configuration in which the heating rate is reduced by reducing the power supply to the halogen heater 23 in the second mode as compared with the first mode. When the power supply to the halogen heater 23 is reduced, it is conceivable that the heat balance of the fixing roller 21 is balanced at a temperature lower than the first temperature T1, and the temperature is not raised any more. When the warm-up is completed in this state, and the image forming operation is started by shifting to the normal mode, a further time is required for the fixing roller 21 to reach the first temperature T1, so that a fixing failure may occur.

On the other hand, according to the fixing device 9 of the present embodiment, the control unit 31 controls the driving unit 28 to rotate the fixing roller 21 at the first rotation speed in the first mode, and controls the driving unit 28 to rotate the fixing roller 21 at the second rotation speed faster than the first rotation speed in the second mode. That is, in the present embodiment, because the power supply to the halogen heater 23 is not reduced in the second mode, a longer time is required compared with the first mode, but the temperature of the fixing roller 21 can be risen to the first temperature T1. Therefore, according to the fixing device 9 of the present embodiment, defective fixing can be prevented.

Further, since the fixing device 9 according to the present embodiment includes the operation unit 41 for receiving an operation for designating either the first mode or the second mode, the user can designate either the first mode or the second mode depending on whether the reduction of the UFP or the work efficiency is prioritized.

The above embodiment may be modified as follows.

[First Modification]

In the above-described embodiment, the control unit 31 controls the driving unit 28 to rotate the fixing roller 21 at the first rotation speed in the first mode, and controls the driving unit 28 to rotate the fixing roller 21 at the second rotation speed higher than the first rotation speed in the second mode. However, the control unit 31 may be configured to control the halogen heater 23 in the first mode so as to generate heat at a first heat quantity per unit time and to control the halogen heater 23 in the second mode so as to generate heat at a second heat quantity per unit time which is smaller than the first heat quantity per unit time. The halogen heater 23 is controlled by adjusting the power supplied to the halogen heater 23 by the control unit 31. With this configuration, the same effects as those of the above embodiment can be obtained.

[Second Modification]

In the above-described embodiment, an example is shown in which the user specifies the first mode or the second mode by operating the UFP reduction key 44U, but the printer driver setting screen provided in the computer connected to the LAN may be configured to specify the first mode or the second mode.

[Third Modification]

In the above-described embodiment, the fixing roller 21 is heated up to the first temperature T1 at the second temperature raising speed in the second mode, but the control unit 31 may be configured to control the driving unit 28 so as to raise the temperature of the fixing roller 21 at the first temperature raising speed when the temperature measured by the temperature measuring unit 53 is equal to or higher than the second temperature T2 lower than the first temperature T1 in the second mode. For example, the first temperature T1 is 190° C., and the second temperature T2 is 95° C.

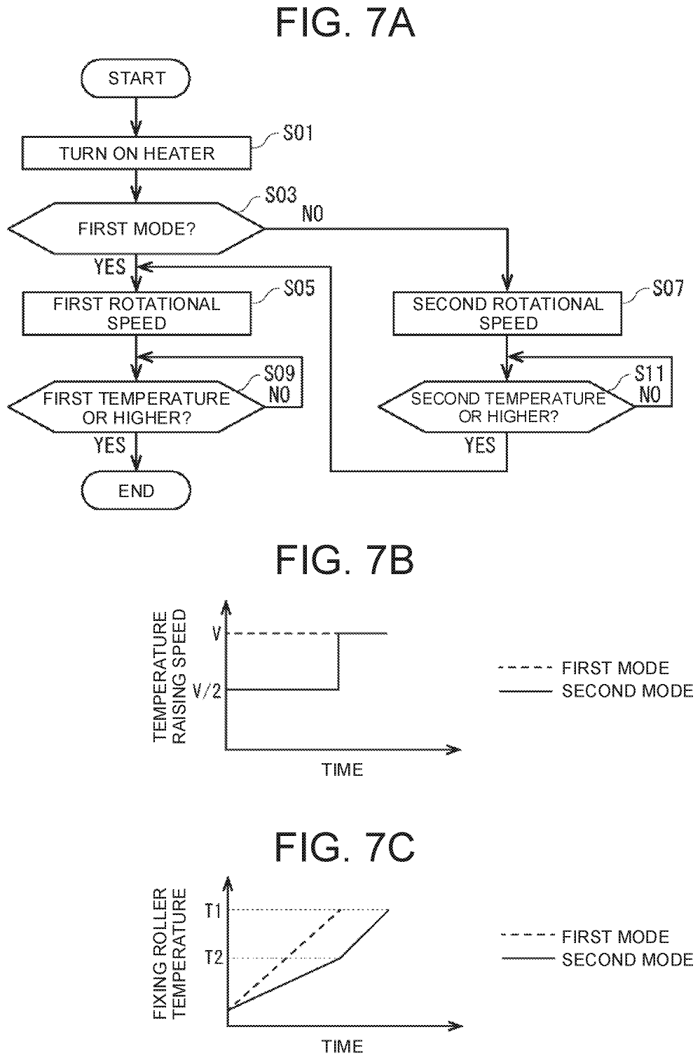

FIG. 7A is a flow chart showing a procedure of controlling warm-up of the fixing device 9. In this modification, step S11 is added after step S07 of the above-described embodiment. In step S11, the control unit 31 determines whether or not the temperature of the fixing roller 21 measured by the temperature measuring unit 53 is equal to or higher than the second temperature T2. If the control unit 31 determines that the temperature of the fixing roller 21 is equal to or higher than the second temperature T2 (step S11: YES), the process proceeds to step 505, and the driving unit 28 is controlled to rotate the fixing roller 21 at the first rotation speed. On the other hand, if the control unit 31 determines that the temperature of the fixing roller 21 is lower than the second temperature T2 (step S11: NO), the determination in step S11 is repeated.

FIG. 7B is a graph showing the temperature raising speed of the fixing roller 21. FIG. 7C is a graph showing the temperature of the fixing roller 21. In the experiment described above, it has been confirmed that the amount of UFP generated tends to increase at the initial stage of warm-up. According to the present modification, in the second mode, the temperature is raised at the second temperature raising speed until the temperature of the fixing roller 21 reaches the second temperature T2, and after the temperature of the fixing roller 21 reaches the second temperature T2, the temperature is raised at the first temperature raising speed, so that the effect of reducing the amount of UFP can be maintained at the same level as that in the above embodiment, and the decrease in work efficiency can be suppressed as compared with the above embodiment.

When the operation unit 41 (including the power saving key 44S) is operated or an image forming job is received after the shift to the sleep mode and before the temperature of the fixing roller 21 drops to the second temperature T2, the control unit 31 performs warm-up according to the above-described procedure, but since it is determined in step S11 that the temperature is equal to or higher than the second temperature even if the second mode is designated (step S11: YES), the control unit 31 controls the driving unit 28 to rotate the fixing roller 21 at the first rotational speed (step S05). In this case as well, the decrease in the work efficiency can be suppressed as compared with the above-described embodiment. The same applies to the case where the power is turned on by the power switch 55 before the temperature of the fixing roller 21 drops to the second temperature T2 after the power is turned off by the power switch 55.

[Fourth Modification]

In the third modification, when the temperature measured by the temperature measuring unit 53 is equal to or higher than the second temperature T2 which is lower than the first temperature T1 in the second mode, the control unit 31 heats the fixing roller 21 at the first temperature raising speed. However, the control unit 31 may be configured to control the driving unit 28 so as to raise the temperature raising speed as time passes in the second mode.

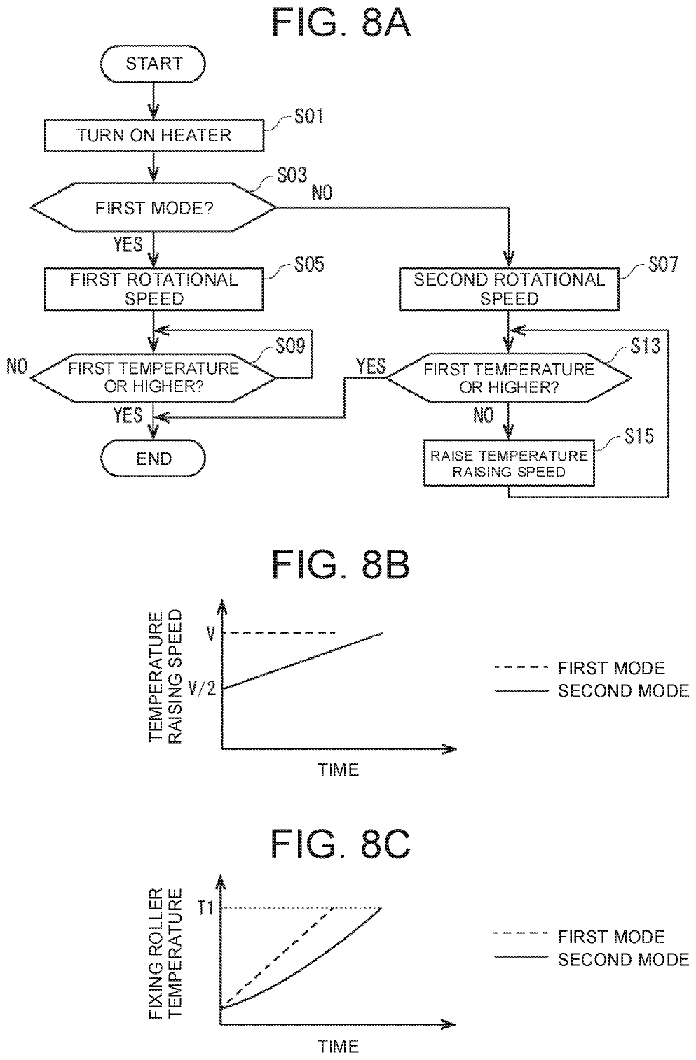

FIG. 8A is a flowchart showing a procedure for controlling warm-up of the fixing device 9. In this modification, steps S13 and S15 are provided instead of step S11 of the third modification. In step S13, the control unit 31 determines whether or not the temperature of the fixing roller 21 measured by the temperature measuring unit 53 is equal to or higher than the first temperature T1. If the control unit 31 determines that the temperature of the fixing roller 21 is equal to or higher than the first temperature T1 (step S13: YES), the warm-up is completed, and if the control unit 31 determines that the temperature of the fixing roller 21 is lower than the first temperature T1 (step S13: NO), the control unit 31 controls the driving unit 28 so as to reduce the rotational speed of the fixing roller 21 by a predetermined amount, thereby raising the temperature raising speed (step S15), and repeats the processing of step S13.

FIG. 8B is a graph showing the temperature raising speed of the fixing roller 21. FIG. 8C is a graph showing the temperature of the fixing roller 21. According to the present modification, in the second mode, the temperature raising speed of the fixing roller 21 is raised as time passes until the temperature of the fixing roller 21 reaches the first temperature T1, so that it is possible to suppress a decrease in work efficiency compared with the above-described embodiment while maintaining the effect of reducing the amount of UFP equal to the above-described-described embodiment. In addition, even in a cold environment, it is possible to reliably raise the temperature of the fixing roller 21 to the first temperature T1.

[Fifth Modification]

When the temperature of the fixing roller 21 is raised in the second mode in a cold environment, in the above-described embodiment, there is a risk that it takes too much time to raise the temperature or the temperature cannot be raised to the first temperature T1. Therefore, in the second mode, the fixing roller 21 may be raised at the first temperature raising speed when the temperature measured by the temperature measuring unit 53 is equal to or lower than the third temperature T3 lower than the first temperature T1.

[Sixth Modification]

When the temperature of the fixing roller 21 is raised in the second mode in a cold environment, it is possible that the temperature of the fixing roller 21 be not raised to the second temperature T2 in the third modification. Therefore, in the second mode, when the temperature measured by the temperature measuring unit 53 is equal to or lower than the third temperature T3 which is lower than the second temperature T2, the fixing roller 21 may be heated at the first temperature raising speed.

[Seventh Modification]

In the above-described embodiment, an example in which the user specifies either the first mode or the second mode has been described, but the control unit 31 may be configured to select either the first temperature raising speed or the second temperature raising speed in accordance with the temperature measured by the temperature measuring unit 53. Specifically, the present disclosure can also be specified as the fixing device 9 comprising the rotatable fixing roller 21, the pressure roller 27 for holding a sheet S between the fixing roller 21 and conveying the sheet S, the driving unit 28 for driving the pressure roller 27, the halogen heater 23 for heating the fixing roller 21, and the temperature measuring unit 53 for measuring the temperature of the fixing roller 21, and further comprising the control unit 31 for controlling the driving unit 28 or the halogen heater 23 so as to raise the temperature of the fixing roller 21 to the first temperature T1 at the first temperature raising speed when the temperature measured by the temperature measuring unit 53 is equal to or higher than the second temperature T2 lower than the first temperature T1, and controlling the driving unit 28 or the halogen heater 23 so as to reduce the amount of UFP generated by raising the temperature of the fixing roller 21 at the second temperature raising speed lower than the first temperature raising speed when the temperature measured by the temperature measuring unit 53 is lower than the second temperature T2. This configuration also makes it possible to reduce the amount of UFP generated when the temperature of the fixing roller 21 is raised.

[Other Modifications]

In the above-described embodiment, the present disclosure has been applied to the fixing device 9 having the halogen heater 23, but the present disclosure may be applied to the fixing device 9 having the induction heating heater, the planar heater or the like instead of the halogen heater 23. In the above-described embodiment, the present disclosure has been applied to the fixing device 9 having the fixing roller 21 (an example of a fixing member), but the present disclosure may be applied to the fixing device 9 having the fixing belt (an example of a fixing member) instead of the fixing roller 21. In the above-described embodiment, the present disclosure has been applied to the fixing device 9 in which the driving unit 28 drives the pressure roller 27, but the present disclosure may be applied to the fixing device 9 in which driving unit 28 drives fixing roller 21.

What is claimed is:

1. A fixing device comprising:
a rotatable fixing member;
a pressure roller for holding and conveying a sheet between the pressure roller and the fixing member;
a driving unit for driving the pressure roller or the fixing member;
a heating unit for heating the fixing member; and
a control unit for controlling the driving unit or the heating unit,
wherein the control unit receives an instruction for designating any of: a first mode in which a temperature of the fixing member is raised at a first temperature raising speed; and a second mode in which a temperature of the fixing member is raised at a second temperature raising speed slower than the first temperature raising speed to reduce a generation amount of ultrafine particles compared with the first mode, and
raises the temperature of the fixing member to a first temperature at a temperature raising speed in accordance with the instruction.

2. The fixing device according to claim 1 further comprising
a temperature measuring unit for measuring a temperature of the fixing member,
wherein in the second mode, when the temperature measured by the temperature measuring unit is equal to or higher than a second temperature lower than the first temperature, the control unit controls the driving unit or the heating unit so as to raise the temperature of the fixing member at the first temperature raising speed.

3. The fixing device according to claim 1,
wherein in the second mode, the control unit controls the driving unit or the heating unit so as to raise the temperature raising speed as time passes.

4. The fixing device according to claim 1,
wherein the control unit controls the driving unit to rotate the fixing member at a first rotational speed in the first mode, and controls the driving unit to rotate the fixing member at a second rotational speed higher than the first rotational speed in the second mode.

5. The fixing device according to claim 1,
wherein the control unit controls the heating unit so as to generate heat with a heat quantity per first unit time in the first mode, and the control unit controls the heating unit so as to generate heat with a heat quantity per second unit time which is smaller than the heat quantity per first unit time in the second mode.

6. The fixing device according to claim 1 further comprising
an operation unit for receiving an operation for specifying either the first mode or the second mode,
wherein the control unit controls the driving unit or the heating unit so as to raise the temperature of the fixing member at a temperature raising speed corresponding to an operation received by the operation unit.

7. A fixing device comprising:
a rotatable fixing member;
a pressure roller for holding and conveying a sheet between the pressure roller and the fixing member;
a driving unit for driving the pressure roller or the fixing member;
a heating unit for heating the fixing member;
a temperature measuring unit for measuring a temperature of the fixing member; and
a control unit for controlling the driving unit or the heating unit,
wherein the control unit raises a temperature of the fixing member to the first temperature at the first temperature raising speed, when the temperature measured by the temperature measuring unit is equal to or higher than a second temperature lower than the first temperature; and raises a temperature of the fixing member at a second temperature raising speed slower than the first temperature raising speed, when the temperature measured by the temperature measuring unit is less than the second temperature.

8. An image forming apparatus comprising:
a fixing device according to claim 1; and
an image forming device for forming the toner image on the sheet.
